(19) United States
(12) Patent Application Publication
(10) Pub. No.: US 2008/0313704 A1
(43) Pub. Date: Dec. 18, 2008

(54) Electronic Message Authentication

(75) Inventors: Arapaut V. Sivaprasad, Crafers (AU); Manish K. Goel, London (GB); Adesh K. Goel, Charlestown (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BoxSentry Pte Ltd., Singapore (SG)

(21) Appl. No.: 11/793,945

(22) PCT Filed: Oct. 23, 2006
(86) PCT No.: PCT/AU2006/001571

§ 371 Date: Jun. 18, 2008

(30) Foreign Application Priority Data
Oct. 21, 2005 (AU) 2005905838

(51) Int. Cl. G06F 21/00

(52) U.S. Cl. 726/2

(57) ABSTRACT

This invention concerns electronic message authentication, such as email messages, to ensure valuable messages are reliably delivered to the recipient, while reducing the delivery of unwanted messages. The invention involves: Receiving an electronic message addressed to a recipient. Rejecting messages sent to unknown recipients, from compromised machines or otherwise found invalid. Testing the messages to valid recipients to determine whether the status of the sender of the message can be categorised as trusted or not-trusted. If the status of the sender cannot be categorised either way, then automatically sending a challenge message, and holding the received message pending receipt of a reply. If an acceptable reply is received, categorising the sender as trusted. And, if the sender is categorised as trusted, delivering the message to the recipient.

### TECHNICAL FIELD

This invention concerns electronic message authentication, such as email messages, to ensure valuable messages are reliably delivered to the recipient, while reducing the delivery of unwanted messages. In a first aspect the invention is a method for electronic message authentication. In another aspect the invention is a system which implements the method, and in a further aspect the invention is software for performing the method.

### BACKGROUND ART

Email is now a ubiquitous and low cost form of communication between people across publicly accessible computer networks, such at the Internet. The accessibility and use of email is continually increasing in both business and private communities. Further, the senders of email generally expect their email to be delivered and to be of value to the recipient. The sender will often be disappointed if their email is not actioned within a short period of time after receipt. Email is also generated by users in many different languages, including English.

Email is, of course, generated using computers, and software robots have been designed to compile and transmit the same email to many recipients simultaneously. This facility can be used not only to transmit, for instance, newsletters to interest groups, but also to transmit unsolicited and indiscriminate mass mailings. A consequence is that many users find their mail box filling with wanted emails from both known and unknown sources, and in addition nuisance emails from unknown sources.

As the volume of nuisance emails grows more time is consumed in identifying and deleting them. For an organization, significant resources can be wasted, whether at individual employee's desktop level or in centralised IT support, and the overall productivity of the organisation can be adversely effected. Moreover, the organisation may be required to invest in additional network storage or bandwidth in order to cope with the extra volume of emails received.

Some organisations attempt to exclude nuisance emails by applying blocking or filtering criteria against the incoming mail stream. However, mass mailing operators have responded by disguising their nuisance emails.

One method employed to filter nuisance emails is to block the reception of any email according to the senders email address, domain address or name. However, this technique can be defeated by changing the senders address. This can be done automatically by computers that incrementally change the senders address between each mass mailing. For example the senders email address may be philr1210@nameofemailserver.com for a first mass mailing, then philr1211@nameofemailserver.com on a second mass mailing; and philr1212@nameofemailserver.com on the third mass mailing and so on.

In other cases mass mailing operators may use fake or non existent return addresses to avoid email address list blocking criteria. Sometimes, they even use the recipients own email address as the return address.

Another method employed to filter nuisance emails is to block the reception of any email according to the contents of the subject line of incoming emails. However, this technique can be defeated by using phoney, misleading or miss-spelt subject headings in the emails; for instance, ‘re: you are this months prize winner” or “Loose weight in only 7 days”.

A further method employed to filter nuisance emails is to block messages according to an analysis of the email's contents. For example, it is possible to identify nuisance emails by the recurrence of nuisance messages, by generic or common language traits, or by previously identified statistical profiles of nuisance emails. However, this technique can be defeated once the filtering criteria has been identified.

In general, apart from requiring continual improvement, filtering methods suffer from the disadvantage that valuable emails can be accidentally blocked by inadvertently meeting the filtering criteria. In some organisations this has led to temporary storage of all the blocked emails and a manual check through them each day.

### DISCLOSURE OF THE INVENTION

In a first aspect the invention is a computer method for authenticating electronic messages (written, voice or data) received from a public communications network, comprising the steps of:
Rejecting electronic messages which are sent to unknown recipients;
Rejecting electronic messages which have originated from compromised machines (those for instance with viruses or part of botnets);
Rejecting electronic messages otherwise readily distinguishable as being invalid;
Testing electronic messages addressed to valid recipients to determine whether the status of the sender of the message can be categorised as trusted or not-trusted;
If the sender can be categorised as trusted, testing the sender's originating source to ensure it is a valid source, and if so categorising the sender as authenticated;
If the status of the sender cannot be categorised either way, then applying tests to determine whether or not the electronic message is invalid or spam, and if so rejecting the message; otherwise automatically sending a request for authentication, and holding the received message in quarantine pending receipt of a reply;
If an acceptable reply is received, categorising the sender as trusted and authenticated; And,
If the sender is categorised as trusted and authenticated, delivering the message to the recipient.

Most email filtering methods adopt a principle whereby email is considered “guilty” until it can be proven to be innocent. In contrast the invention uses an approach whereby an email is considered “innocent” until proven guilty.

The invention employs several heuristics-based checks to test the electronic messages addressed to valid recipients and determine the status of the sender. These checks may include, but are not limited to checking:

The sender's history of email communications
The sender domain's reputation
The sender IP's reputation
Checking the mail content (in multiple languages)
The sender's compliance with published email standards (eg RFC rules)
The sender's presence on an accepted list maintained by the recipient
Applying Bayesian methodology to determine an email's authenticity, and
Validity mail tracking by recipient
When a sender is determined to be trusted the invention may use pro-active pushing to “fast track” delivery of legitimate emails.

The method may include the additional step of testing the message to determine whether it has been spoofed, and if so rejecting the message, subjecting it to further examination and/or possibly categorising the sender as not-trusted.

The step of testing for spoofing may involve the step of investigating metadata accompanying the message. For instance:
The metadata may be read to determine the address of the sender, and this may be compared against known trusted and not-trusted addresses.
The sender identity framework (SIDF), or domain key identity management (DKIM), may be tested, and where the originating domain has adopted a standard messages will be rejected if they fall outside that standard.
Checking bounce messages.
Checking CSA records.

When a spoof is detected a request for self-authentication may be sent to the address of the originator or to the intended recipient depending upon the circumstances.

Anti-phishing tests may also be conducted on incoming messages to verify the identity of the sender using anti-phishing data and/or anti-phishing detection software.

A request for authentication may be sent to either the address of the sender (self-authentication) or the recipient, or both, depending on user preferences.

Before a request for self authentication is sent to the sender, checks may first be conducted to identify the sender as a real user. These checks may include:
Domain and user.
“Spam” check.
Outstanding SSA check.
Flood check.
Originator SSA block check.
Anti-Spoof check.
Check that the message can be sent.

A self-authentication request to a sender to verify themselves may be sent in the language of the sender. It may include the following details:
Intended message recipient,
Intended message subject,
An Accept URL for the SSA recipient to validate themselves,
A message informing the users the purpose of the SSA,
A distributor signature line,
A RealMail signature line,
The first few lines of the message
An optional mail to phrase in the text body part only.
An extract of the message headers

A Reject URL for the SSA recipient to inform the system that they have inadvertently received the SSA message as a ‘back-scatter’,

An incoming request for authentication informs a recipient that an incoming message destined for them has been held in their holding tray. The message may include the following details:
Message originator,
Message subject,
A rating or ranking of the validity of the email as determined by the system
A URL that links user to their holding tray to deal with the message,
Details of how the user may allow the message to be released or rejected.

While a message is quarantined in the holding tray, it may be available for review by the intended recipient. Messages may be sent to the intended recipient to encourage such review. The held messages may be purged from time to time according to predefined rules.

The holding tray may code the held messages, for instance:
Probably valid.
Possibly valid.
Probably spam.
Spam.
Urgent.

Different rules may apply to different categories, and these might apply an action in the event of review by the intended recipient, reply to the challenge or passage of time. The actions might change the category of the message, accept, reject or delete it.

The intended recipient may review a message in the holding tray and apply an action to change the category of the message, accept, reject or delete it.

The following actions may be defined:
Accept, causes the originator to be added to their accept list.
Review causes no action to take place.
Reject, causes the originator to be added to their reject list.
Delete, deletes the message from storage.

An acceptable reply to a challenge message may be a reply that indicates a human has responded to the challenge, possibly within a predetermined time.

If a sender is categorised as not-trusted the message is not delivered but rejected or deleted, and the sender's address may be added to a list of not-trusted senders, that is the reject list.

Realtime Blackhole lists (RBL) may be checked to identify known spam originators.

Three levels of reject lists may be employed, those managed by the user, domain and system.

Also, trusted third party lists may be consulted to determine whether the email originator is trusted. Different levels of accept lists may be employed including, those managed by the user, domain and system.

Outgoing mail may also be checked for validity, viruses or content and other rules which comply with a user or organisation's electronic communications policy.

A major use of the invention may be in the management of email, but it may also be applied to many other forms of messaging including the short message service (SMS), provided to cell phones and also Voice-over-Internet-Protocol (VOIP), internet based telephony. VOIP uses similar standards to email for delivery and connectivity hence is analogous to the above in relation to the invention for authentication.

In addition to the above, the invention is able to provide protection against:
virus transmission via email
   Denial Of Service (DOS) and Distributed DOS (DDOS) attacks

### Directory Harvest Attacks (DHA)

The invention may reduce the bandwidth usage of mailservers by up to 60%, by employing perimeter protections as above.

The invention may reduce errors in categorisation of legitimate email as “spam” email (“false positives”) to virtually zero. The invention may reduce errors in categorisation of legitimate email originated by a human sender for a single message (“false critical”) to virtually zero.

In another aspect the invention is a computer message authentication appliance, comprising:

A communications port to receive an electronic message addressed to a recipient. And, A processor operable to:
Reject electronic messages which are sent to unknown recipients;
Reject electronic messages which have originated from compromised machines;
Reject electronic messages otherwise readily distinguishable as being invalid;
Test electronic messages addressed to valid recipients to determine whether the status of the sender of the message can be categorised as trusted or not-trusted, and if the sender can be categorised as trusted, testing the sender's originating source to ensure it is a valid source, and if so categorising the sender as authenticated;
If the status of the sender cannot be categorised either way, then applying tests to determine whether or not the electronic message is invalid or spam, and if so rejecting the message; otherwise automatically sending a request for authentication, and holding the received message in quarantine pending receipt of a reply;
If an acceptable reply is received, categorising the sender as trusted and authenticated; And,
If the sender is categorised as trusted and authenticated, delivering the message to the recipient.

In a further aspect the invention is software for performing the method.

### BRIEF DESCRIPTIONS OF THE DRAWINGS

An example of the invention will now be described with respect to the following drawings:

FIG. 1 is a diagram of a typical installation of the invention.

FIG. 2 is a diagram of a typical architecture of the invention.

FIG. 3 is an example of an outgoing SSA message.

FIG. 4 is an example of an incoming SSA message.

FIG. 5 is a typical Accept URL.

FIG. 6 is a typical Reject URL.

FIG. 7 is an example of an alert message.

### BEST MODES OF THE INVENTION

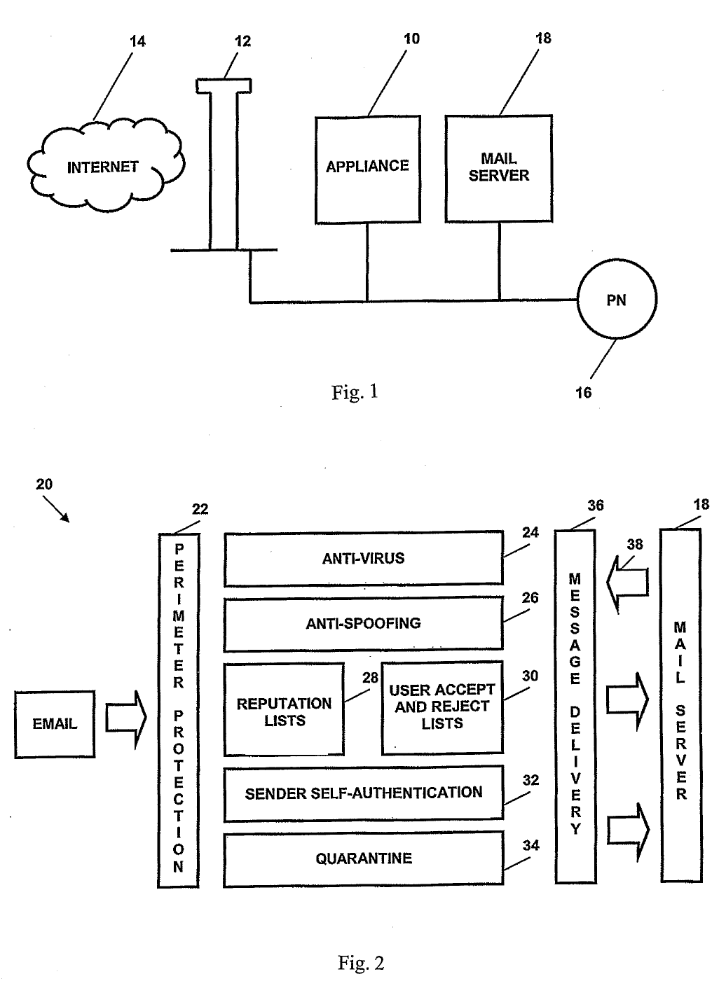

Referring first to FIG. 1, a typical installation for the invention will involve the installation of an authenticating appliance 10 behind a firewall 12 which protects it from the Internet 14. The appliance 10 then interfaces with a private network 16 via an email server 18.

A variety of layers of protection are available to the appliance. Referring to FIG. 2, a typical architecture 20 of the invention will involve the following:
Perimeter protection layer 22 provides physical access protection, general network access protection, code level protection and initial SMTP boundary checks.
Anti-virus layer 24 that checks all incoming and outgoing messages for virus.
Anti-spoofing layer 26 that detects all incoming messages from spoofed addresses.
A layer that checks the validity of message originators and sending mail servers and domains based on industry reputation lists and methods 28.
A layer that checks the validity of message originators based on user's accept and reject lists 30.
Sender self-authentication (SSA) layer 32 that requests message originators to verify themselves when their messages cannot be rejected or identified as either valid.

Once a message has passed through the above layers but still cannot be identified as valid, it will be held in a holding tray. The quarantine automation component 34 allows users to manage messages in their holding tray. The possible mail component informs users of the messages in their holding tray and allows them to act on these messages.

The delivery of all incoming and outgoing messages are handled by the message delivery component 36 of the invention. The outgoing mail component performs checks all outgoing mails, or any connections that have been made or received by the message delivery component, to ensure that they are from valid senders and mail servers.

Each component of the invention is detailed as follows.

### Perimeter Protection 22

A first layer of protection is perimeter protection provided by locating the appliance in a secure data centre, which will allow physical access only to authorised staff.

Incoming mail is defined as any mail, or in fact, any connection that is made or received by the Internet facing component of the appliance (including VOIP). Any connection that is received by the appliance is subject to boundary checks designed to reject as many illegitimate messages as possible, before SMTP delivery is completed, leaving the sending server with responsibility to produce a non delivery report. Any rejections will pass back as much information as possible to the sender to ensure that in the very unlikely event of a legitimate email, adequate information is available to the sender to avoid a false positive.

A boundary check failing will result in the message being rejected by the MTA, using a 5xx code.

The appliance will be configured to disable pipelining, which enables a sending server to send multiple commands in one go. Pipelining is not strictly necessary to SMTP and is frequently used by spammers.

### Anti-Virus 24

Virus checking will be provided for all incoming and outgoing messages. The anti-virus function may be from a given commercial third party products. The anti-virus function may be turned on or off for both inbound and outbound emails.

Any messages that are accepted into the system will be virus checked.

If a virus is detected in an inbound message but both the originator and recipient are valid, the recipient will be sent a warning message detailing the virus detected. The identity of the sender may be further verified using an anti-spoofing test. For example, if the spam detection algorithm scores the message above a threshold, and the IP is different, the message is a spoof. The recipient of a spoofed message will not be sent a warning message. If a virus is detected in an inbound message but the originator or recipient are not valid, the message will be deleted.

If a virus is detected in an outbound message, the message will be deleted and the originator will be sent a warning message. If no virus is detected in a message, it will be delivered to the intended recipient. If a virus checking error occurs, the event will be recorded in a log file.

### Anti-Spoofing 26

A spoof is defined as a message that purports to be from a particular address, but is in fact from a spammer who is using that user's address for malicious purposes. If a message arrives from an originator on a user's accept list, but the IP address does not match with the one found in the accept list, the message is presumed to be a spoof.

When an message presumed to be a spoof is detected, the message will be delivered to the back end server. The back end server then carries out a sender verification check by sending a message to the originator on the new IP address.

Anti-phishing tests may be included to verify the identity of the sender. Phishers usually attempt to fraudulently acquire sensitive information, such as password and credit card numbers, by masquerading as a trustworthy person or business in a message. Specific third party anti-phishing data is interrogated. Also, specific third party anti-phishing software may be used to detect phishing messages.

### Industry Reputation Lists and Methods 28

The invention may use industry reputation lists and methods to check the validity of message senders and sending Mail Transport Agents (MTAs) or domains, in addition to the local accept list. For example, a Realtime Blackhole List (RBL) is a list that is provided by third parties that details hosts are known to send spam, viruses and other malicious mails.

The invention checks all incoming messages against the industry reputation lists and updates the lists regularly. Where a message is on an RBL list, the message will be rejected unless the originator is know to the intended recipient. In such a case the message will be delivered.

All incoming messages will be checked against third party reputation lists (including Bonded Sender and Habeas). A message will be accepted if the originator is on the list. Messages accepted will not be subject to further analysis but will be virus checked

All incoming messages will have their domain sender identity framework (SIDF) or SPF records checked. A message is unaffected if the domain does not advertise SIDF records or the domain advertises ‘soft-fail’ records. A message will be rejected if the domain does not advertise ‘soft-fail’ records and the message does not match these records. A failure will result in a 5xx code to the sending MTA with complete details as to why the message was rejected. The assumption is that if a domain implements SIDF, it usually intends to adhere to the framework. Messages outside the framework will therefore fail.

If an incoming message is signed using DKIM, this information will be verified. If the keys do not match, the record will be rejected. Only records for domains that send all outgoing mails via the servers, or that implement DKIM on their outgoing servers, will be published.

If an incoming message is a bounce message, a BATV check will be performed on it. The message will be rejected if the check fails. The check enables the MTA to identify spoofed bounce messages.

All incoming messages will have their CSA records checked. A message will be rejected if its CSA information does not match the CSA information advertised by the domain.

All incoming messages will be checked to see whether they are from RealMail authorised senders. If the domain preferences are set to allow messages from other RealMail customers then the message will be specifically accepted, and not subject to spam checking, but it will be virus checked.

### User Accept and Reject Lists 30

User accept and reject lists are compiled to check the validity of message originators. The accept and reject lists contain a list of the trusted and non-trusted originators respectively.

There are three levels of accept list:
A user accept list, managed by the user, that details the tlds, domains or addresses that the user will accept messages from;
A domain accept list, managed by the domain administrator, that details the tlds, domains or addresses that users of the domain will accept messages from; and
A system accept list, managed by the systems administrator, that details the tlds, domains or addresses that all users of the system will accept messages from.

Similarly, there are three levels of reject list:
A user accept list, managed by the user, that details the tlds, domains or addresses that the user will reject messages from;
A domain accept list, managed by the domain administrator, that details the tlds, domains or addresses that users of the domain will reject messages from; and
A system accept list, managed by the systems administrator, that details the tlds, domains or addresses that all users of the system will reject messages from.

### Authentication

A message for a valid recipient may be tested to determine whether the sender can be categorised as trusted or not-trusted. One of the tools available for authentication is a request for authentication. A request for authentication may be sent to either the message originator, or the message recipient, or both, depending on the user preferences. The message enables the system to validate the originator address. If a message cannot be sent to a valid address, then no request for authentication will be sent.

### Recipient Sender Authentication

An incoming request for authentication informs a recipient that an incoming message destined for them has been held in their holding tray. The message may include the following details:
Message originator,
Message subject,
A URL that links user to their holding tray to deal with the message,
Details of how the user may allow the held message to be released or rejected.

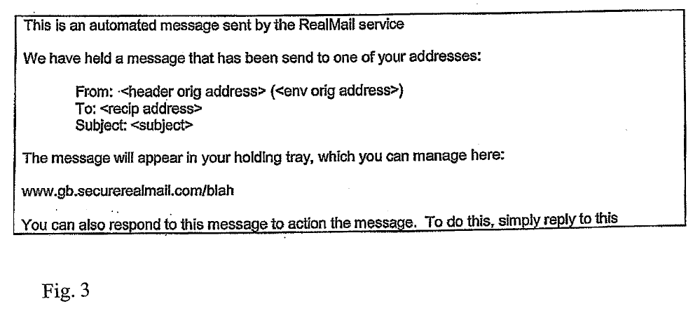

An example of an incoming request for authentication is shown in FIG. 3. A message held in a user's holding tray will remain there until the user either accepts, rejects or puts the message under review. Replying to the held message with ‘accept’ adds the originator to the user's accept list, ‘reject’ adds the originator to the user's reject list and ‘review’ does not change any lists.

### Sender Self Authentication (SSA) 32

When a message cannot be specifically identified as valid, or cannot be rejected by perimeter checks, it must be examined more closely to determine whether a request for self-authentication (SSA message) should be sent to the message originator. An SSA message is an email that is sent to the originator of the message, informing them that the message has been held by the system. It invites them to self authenticate using a one-click link.

The invention will minimise the SSA messages that are sent out, and conduct all possible checks to ensure that SSA messages are only sent to real users

Before sending an SSA message to a message originator, the SSA engine will perform the following pre-send checks:
Domain and user preference check to ensure that no SSA will be sent if the domain or the user do not want to send any SSAs.
SPAM check to review the message for standard SPAM characteristics. If it is likely to be a spam message, an SSA will not be sent.
Outstanding SSA check to ensure that there is no outstanding SSA. If there is and the number of outstanding SSAs is more than a user-defined limit, another SSA will not be sent.
Flood check to avoid sending the originator additional SSAs until its number of outstanding SSAs falls below a user-defined threshold. In order to prevent a DOS, two SSAs should not be sent less than 5 minutes apart.
Anti-Spoof check, as detailed earlier.

An outgoing SSA message is a simple message that requests the message originator to verify themselves. It may include the following details:
Intended message recipient,
Intended message subject,
A Accept URL for the SSA recipient to validate themselves,
A Reject URL for the SSA recipient to inform the system that they have received the SSA message as a ‘back-scatter’,
A message informing the users the purpose of the SSA,
A distributor signature line,
A RealMail signature line,
The first few lines of the message
An optional mailto phrase in the text body part only (sent to realmail.<id>@ . . . ).

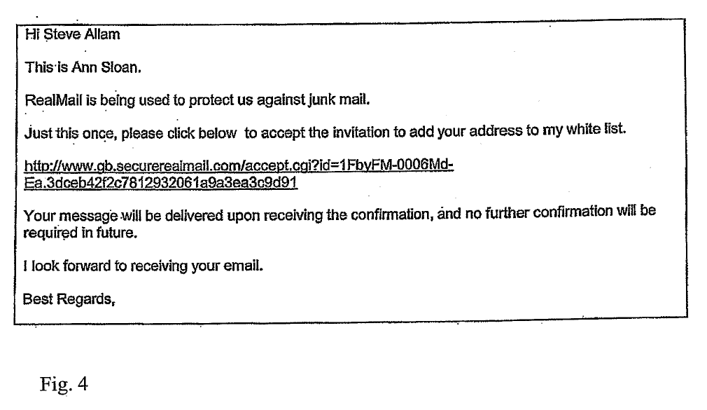

An example of an outgoing SSA message is shown in FIG. 4.

The SSA message, incoming or outgoing, should be a simple text message for all 7-bit character-set countries. The message should be a multipart or alternative text or html message for all non 7-bit character-set countries, including a text part in English and an html part in the other language.

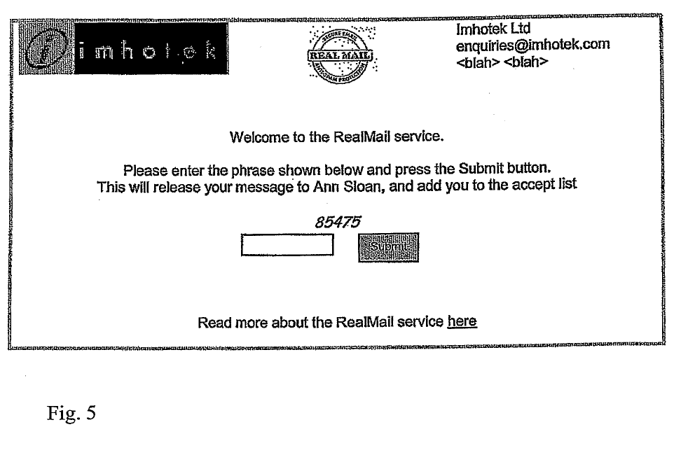

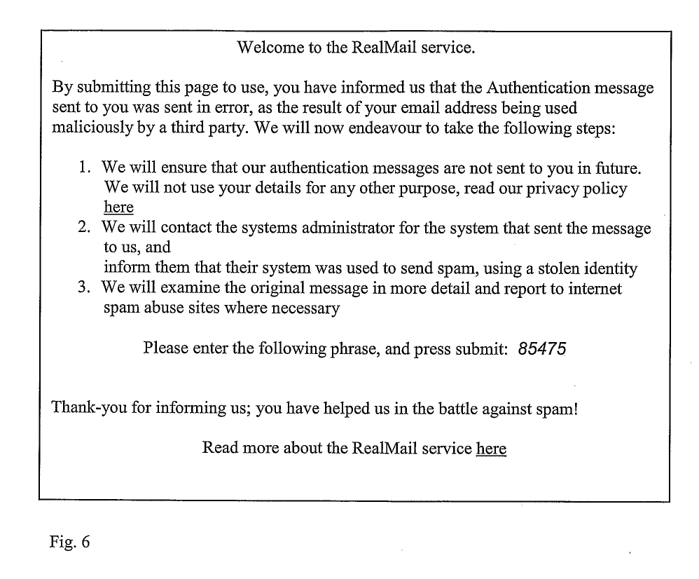

The Accept URL in the outgoing SSA message allows the originator to validate themselves as a real user. An example of an Accept URL is shown in FIG. 5. Once validated, the message will be released, and the message originator added to the recipient's accept list. The Accept URL only provides users with the option to verify that they are the correct originator of the message, so that the message can be released. Users must enter a ‘catchpa’ phrase to complete the Accept URL submission, or a number, or a simple click, as per user preferences.

Both the Accept and Reject URLs in the SSA message may be fully templated to allow domain owners to modify their company name and logo, provide custom page footer and header and change some of the accept or reject text.

### Quarantine Automation 34

Once the message has passed through perimeter protection, anti-virus, anti-spoofing, industry reputation lists checks and user accept lists checks, it will reach the quarantine automation module. The message may have resulted in a request for authentication message being sent to either the originator or recipient of the message, or both. Quarantine automation covers what happens to a message once it is in the holding queue of the system.

The purpose of quarantine automation is to:
Make messages available for user review through their holding tray.
Periodically inform users of held messages.
Ensure that the SSA process completes.
Purge messages according to defined rules.
Application of additional checks to further validate the message.

The holding tray allows the user to view messages that have been held for them, or are waiting for the response to an outgoing SSA message. An end-user will be able to see messages that have been sent to their addresses. A domain administrator will be able to see messages that have been sent to all addresses on their domains. All messages in the holding tray will have been through the checks as detailed in the previous sections. The results of these checks will be used to modify the view of the messages accordingly

The holding tray may categorise messages using different colours. Examples of categories and the corresponding colours are
Probably Valid, in maroon, to indicate a message that has a low score on heuristic checks, and an outstanding SSA;
Possibly Valid, in violet, to indicate a message that has a low score on heuristic checks, but the SSA has timed out;
Probably Spam, in black, to indicate a message that has a borderline score on heuristic checks, and no SSA was sent;
Spam, in grey, to indicate a message that has a high score on heuristic checks, and no SSA was sent; and
Urgent, in red, to indicate a message that requires an urgent action.

The digest time interval for messages in the second Possibly Valid category may be the same as SSA timeout. However, SSA that comes at a later time may still be accepted. Messages in the Possibly Spam category should be sent an SSA. There are two thresholds for identifying a message as a Spam. If it is below the valid threshold and has a low score on heuristic checks, it remains Possibly Valid until an SSA message is replied by the originator. However, if the originator has been sent more than a user-defined number of SSA messages, the message us marked as a Spam.

Users can manage their holding tray using the following actions:
Accept to accept the message and add the originator to their Accept List.
Review to accept the message but do not add the originator to their Accept List and the message will remain in the holding tray.
Reject to add the originator to their reject list.
Delete to remove the message from the holding tray and the database.

The SSA process described in the last section may result in a SSA message being sent to either the originator or recipient of a message. Once the SSA has been sent, the message remains in the user's holding tray until the SSA is accepted or rejected. The outstanding SSA should expire after a set, user defined period, after the resend periods have elapsed.

Messages in the holding tray should be purged according to user and system defined preferences. A user or administrator can have all, Possibly Spam and Possibly Valid messages to be purged after a user-defined number of days.

### Message Delivery 36

The component of the invention that delivers messages is the MTA. Messages that are delivered can be classified as follows:
Messages from valid senders that will be delivered to the local mail servers.
Messages from other mail servers that use the invention that will be delivered to the local mail servers.
Messages from SSA validated senders that will be released to the local mail servers.
SSA messages.
Delivery reports from remote servers.
Delay messages from local mail servers.
Outgoing messages from local mail servers.

There can be one or more local mail servers in use. The MTA will attempt to deliver messages, either from other valid senders or mail servers that use the invention, to these local servers for a total of 5 days, before returning a failure to the sender of the message.

Messages that have been released by the SSA module will be submitted to a front-end server for delivery. An outgoing message from a customer may receive a delivery report from a remote server. This message will be checked for validity and delivered to the customer in good faith. The MTA of the invention will attempt to deliver outgoing messages for a number of days and will generate warning messages when the delivery fails. These warning messages will be delivered to the customer.

### Outgoing Mail 38

An outgoing mail is any mail received by the MTA component of the invention that claims to be from a valid mail server of the user of the invention. Users of the invention that have their own server should have their server deliver all outgoing mail to the servers of the invention. Users who have a domain hosted by an ISP may be able to direct all their individual outgoing mail to the servers of the invention, for example, using SMTP_AUTH accounts provided by the appliance.
Virus check, as described earlier.
Accept list check to look up the message recipient pair in the originators accept list. The recipient will be added to the list if not found on the list.
Outbound content or rate check to check the file type, destination rate, key words and spam score of the message. If a domain has an outgoing filter set, then MTA will be passed to STIMd—the program that handles incoming mails—for processing. STIMd will provide checks and carry out actions as required.

In addition, a footer that can be modified by each domain may be added to all outgoing messages. Outbound messages that are blocked will be held in an outbound holding tray, or messages will be allowed through, whilst informing an administrator.

### Possible Mail Alerts

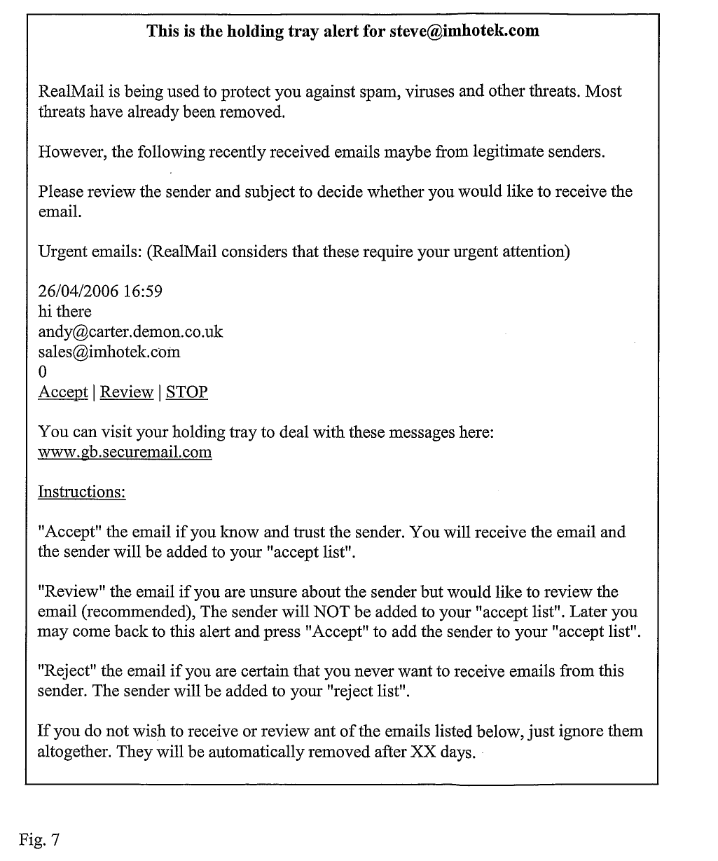

Possible mail alerts is the mechanism used to inform users of messages sitting in their holding tray. The alerts are sent according to user preferences, and depending on the number and type of messages in the holding tray. An example of a possible mail alert is shown in FIG. 7. The format, contents and frequency of the alerts are defined by the preferences set by the domain administrator and users.

Users are allowed to set their preferences for the frequency of the alert messages, maximum limit of the number of alert messages, message format, message content, message type included in the alert messages and a timer to temporarily stop the alert messages. The domain administrator can set the defaults for the domain for all the user preferences and additional preferences.

1. A computer method for authenticating electronic messages received from a public communications network, comprising the steps of:
rejecting electronic messages which are sent to unknown recipients;
rejecting electronic messages which have originated from compromised machines;
rejecting electronic messages otherwise readily distinguishable as being invalid;
testing electronic messages addressed to valid recipients to determine whether the status of the sender of the message can be categorised as trusted or not-trusted;
if the sender can be categorised as trusted, testing the sender's originating source to ensure it is a valid source, and if so categorising the sender as authenticated;
if the status of the sender cannot be categorised either way, then applying tests to determine whether or not the electronic message is invalid or spam, and if so rejecting the message; otherwise automatically sending a request for authentication, and holding the received message in quarantine pending receipt of a reply;
if an acceptable reply is received, categorising the sender as trusted and authenticated; and,
if the sender is categorised as trusted and authenticated, delivering the message to the recipient.

2. The method according to claim 1, including the additional step of testing the message to determine whether it has been spoofed.

3. The method according to claim 2, wherein the step of testing for spoofing involves the step of investigating metadata accompanying the message to determine at least one of the following:
whether the address of the sender is a known trusted address, or a not-trusted address;
whether the originating domain has adopted an identification standard;
whether the message is a bounce message; or
whether the message CSA records are valid.

4. The method according to claim 1, including the additional step of conducting an anti-phishing test to verify the identity of the sender.

5. The method according to claim 1, wherein a request for authentication is sent either the address of the sender or the recipient, or both, depending on user preferences.

6. The method according to claim 5, wherein a request for authentication is sent to the sender only in the event they are identified as real users.

7. The method according to claim 5, wherein a request for authentication sent to the address of the sender is sent in their own language.

8. The method according to claim 7, wherein the request for authentication sent to a sender includes one or more of the following details:
the message recipient,
the message subject,
an Accept URL for the challenge message recipient to validate themselves,
a Reject URL,
a message explaining the purpose of the challenge,
a distributor signature line,
the first few lines of the message.

9. The method according to claim 6, wherein a request for authentication sent to the address of the intended recipient, and includes one or more of:
the message originator,
the message subject,
a URL that links the recipient to their holding tray to deal with the message,
details of how the recipient is able to allow the message to be released or rejected.

10. The method according to claim 1, wherein while a message is quarantined, it is held in a holding tray where it is available for review by the intended recipient.

11. The method according to claim 10, wherein alerts are sent to the intended recipient to encourage review.

12. The method according to claim 10, wherein the held messages are purged from time to time according to predefined rules.

13. The method according to claim 10, wherein the holding tray codes the held messages to indicate their acceptability status.

14. The method according to claim 13, wherein different actions are allowable following review by the intended recipient depending on the acceptability status of a message.

15. The method according to claim 14, wherein the action is to change the category of the message, accept, reject or delete it.

16. The method according to claim 1, wherein an acceptable reply to a challenge message indicates a human has responded to the challenge.

17. The method according to claim 1, wherein in the event a sender is categorised as not-trusted the message is not delivered, and the sender's address is added to a list of not-trusted senders.

18. The method according to claim 1, wherein outgoing mail is checked for validity, viruses or content.

19. A computer message authentication appliance, comprising:
a communications port to receive an electronic message addressed to a recipient, and a processor operable to:
reject electronic messages which are sent to unknown recipients;
reject electronic messages which have originated from compromised machines;
reject electronic messages otherwise readily distinguishable as being invalid;
test electronic messages addressed to valid recipients to determine whether the status of the sender of the message can be categorised as trusted or not-trusted, and if the sender can be categorised as trusted, testing the sender's originating source to ensure it is a valid source, and if so categorising the sender as authenticated;
if the status of the sender cannot be categorised either way, then applying tests to determine whether or not the electronic message is invalid or spam, and if so rejecting the message; otherwise automatically sending a request for authentication, and holding the received message in quarantine pending receipt of a reply;
if an acceptable reply is received, categorising the sender as trusted and authenticated; and,
if the sender is categorised as trusted and authenticated, delivering the message to the recipient.

20. The appliance according to claim 19, wherein the processor is also operable to reject electronic messages that have been spoofed.

21. The appliance according to claim 20, wherein to test for spoofing the processor investigates metadata accompanying the message to determine at least one of the following:
whether the address of the sender is a known trusted address, or a not-trusted address;
whether the originating domain has adopted an identification standard;
whether the message is a bounce message; or,
whether the message CSA records are valid.

22. The appliance according to claim 19, wherein the processor performs the additional step of conducting an anti-phishing test to verify the identity of the sender.

23. The appliance according to claim 19, wherein a request for authentication is sent either the address of the sender or the recipient, or both, depending on user preferences.

24. The appliance according to claim 23, wherein a request for authentication is sent to the sender only in the event they are identified as real users.

25. The appliance according to claim 23, wherein a request for authentication sent to the address of the sender is sent in their own language.

26. The appliance according to claim 25, wherein the request for authentication sent to a sender includes one or more of the following details;
the message recipient,
the message subject,
an Accept URL for the challenge message recipient to validate themselves,
a Reject URL,
a message explaining the purpose of the challenge,
a distributor signature line,
the first few lines of the message.

27. The appliance according to claim 24, wherein a request for authentication sent to the address of the intended recipient, and includes one or more of:
the message originator,
the message subject,
a URL that links the recipient to their holding tray to deal with the message,
details of how the recipient is able to allow the message to be released or rejected.

28. The appliance according to claim 19, wherein while a message is quarantined, it is held in a holding tray where it is available for review by the intended recipient.

29. The appliance according to claim 28, wherein alerts are sent to the intended recipient to encourage review.

30. The appliance according to claim 28, wherein the held messages are purged from time to time according to predefined rules.

31. The appliance according to claim 28, wherein messages held in the holding tray are coded to indicate their acceptability status.

32. The appliance according to claim 31, wherein different actions are allowable following review by the intended recipient depending on the acceptability status of a message.

33. The appliance according to claim 32, wherein the action is to change the category of the message, accept, reject or delete it.

34. The appliance according to claim 19, wherein an acceptable reply to a challenge message indicates a human has responded to the challenge.

35. The appliance according to claim 19, wherein in the event a sender is categorised as not-trusted the message is not delivered, and the sender's address is added to a list of not-trusted senders.

36. The appliance according to claim 19, wherein outgoing mail is checked for validity, viruses or content.

37. Software for performing the method according to claim 19.
